(19) United States
(12) Patent Application Publication
(10) Pub. No.: US 2009/0190165 A1
(43) Pub. Date: Jul. 30, 2009

(54) Link system

(75) Inventor: Hajime Yoshida, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/320,673

(22) Filed: Jan. 30, 2009

(30) Foreign Application Priority Data
Jan. 30, 2008 (JP) 2008-019856

(51) Int. Cl. G06F 3/12; G06F 21/00; G06F 3/048; G06F 15/16

(52) U.S. Cl. 358/1.15; 726/3; 715/740; 709/203; 709/230

(57) ABSTRACT

In a link system in which a plurality of MFPs and a server apparatus is connected so as to enable data communication over a network, a remote connection driver of the MFP starts an application on the server apparatus by remote control and at the time, on the basis of an operation start signal transmitted from the MFP, a device setting manager of the server apparatus identifies as a remote operation host apparatus the MFP having transmitted the operation start signal, and automatically sets the MFP as the MFP by which the application is used.

### CROSS-REFERENCE TO RELATED APPLICATION

This application claims priority to Japanese Patent Application No. 2008-019856, which was filed on Jan. 30, 2008, the contents of which are incorporated herein by reference in its entirety.

### BACKGROUND OF THE INVENTION

1. Field of the Invention

The present invention relates to a link system in which a plurality of image forming apparatuses and a server apparatus are connected so as to enable data communication over a network.

2. Description of the Related Art

There has been known a technique of SHARP OPEN SYSTEMS ARCHITECTURE (abbreviated as SHARP OSA: registered trade name) as an example for a method of utilizing a software application function on a personal computer (abbreviated as PC) remotely from a multifunction printer (abbreviated as MFP) by linking the MFP to an existing software on the PC. In SHARP OSA, the remote utilization of a software application function is realized by building a Web application on PC, and making an MFP operate as a Web browser.

Unlike the development of conventional desktop application, the development of Web application however has a lot of problems to be overcome, such that it requires a special know-how or that it causes many troubles in linking to legacy software from the standpoint of security, etc. Accordingly a method of developing an MFP-linking application or the like at low cost by implementing an additional link function in the existing desktop application, instead of using the Web application, has been studied.

Japanese Unexamined Patent Publication JP-A 11-38958 (1999) discloses that a handheld terminal at which a universal operating system (abbreviated as OS) is not available can operate a PC desktop application by remotely activating the application from the handheld terminal.

Also WINDOWS XP (registered trademark) has a remote desktop function that a user can remotely log into a remote PC and thereby activate and use an application thereon. By combining these techniques, it is possible to operate a PC desktop application from an MFP operation panel as well as to enable the application to identify its user. Through this method, an application linked to existing PC software can be easily realized.

In the case of employing the method of providing a linked application as just described, what is to be remotely used is a PC desktop application, and such a desktop application is generally created to be used on a single computer and therefore needs to designate a target image forming apparatus to be controlled to execute a print job, etc. However, it is contemplated that for a user who manipulates an operation panel and thereby uses a desktop application, an image forming apparatus such as a printer or scanner to be controlled is mostly the user's own MFP, and in this case, the operation to select an image forming apparatus to be controlled for each use will be redundant for the user. In the case where a single application is used from a plurality of MFPs, the last setting will be saved, which requires reset of an image forming apparatus to be used for an application each time that a different MFP is used as a remote operation host apparatus, and such operation is troublesome.

### SUMMARY OF THE INVENTION

Accordingly, an object of the invention is to provide a link system that does not require a user to conduct such operation as to select and set an image forming apparatus to be controlled for each use, which therefore allows for enhancement in convenience.

The invention provides a link system in which a plurality of image forming apparatuses and a server apparatus are connected so as to enable data communication over a network,

the image forming apparatus having a remote operating section adapted to make an application on the server apparatus available by remote control, and

the server apparatus having:

a remote operation host apparatus identifying section for identifying a remote operation host apparatus that is an image forming apparatus which is currently performing a remote operation, with the remote operating section, among the plurality of image forming apparatuses connected over a network; and

an automatic setting section adapted to automatically set an image forming apparatus to be used for printing a print job of an application,

wherein the remote operating section of the image forming apparatus starts an application on the server apparatus by remote control,

the image forming apparatus transmits over a network an operation start signal indicative of onset of the remote control, and

the server apparatus receives the operation start signal transmitted from the image forming apparatus, based on which signal:

the remote operation host apparatus identifying section identifies as a remote operation host apparatus the image forming apparatus having transmitted the operation start signal; and

based on an identification result of the remote operation host apparatus identifying section, the automatic setting section automatically sets as the remote operation host apparatus an image forming apparatus to be used for printing by the application.

According to the invention, when the remote operating section of the image forming apparatus activates the application on the server apparatus by remote control, the image forming apparatus transmits over a network the operation start signal indicative of onset of the remote control. And in the server apparatus, the operation start signal transmitted thereto from the image forming apparatus is used by the remote operation host apparatus identifying section to identify as the remote operation host apparatus the image forming apparatus which has transmitted the operation start signal, and on the basis of an identification result of the remote operation host apparatus identifying section, the automatic setting section automatically sets as the remote operation host apparatus the image forming apparatus which is to be used for printing by the application. A user making use of the link system therefore does not need to conduct such operation for each use as to select and set an image forming apparatus which is to be used for printing by the application, thus allowing for enhancement in convenience.

In the invention, it is preferable that the image forming apparatus has a memory section for storing user information registered in advance for each user making use of the image forming apparatus, and an authentication section for identifying and authenticating a user based on the user information stored in the memory section, and the server apparatus has a user identifying section for identifying a user making use of an application by remote control, and a memory section for storing custom setting registered in advance for each user making use of the application by remote control,

wherein when the remote operating section of the image forming apparatus starts an application on the server apparatus by remote control,

the image forming apparatus transmits user information of a user authenticated by the authentication section, to the server apparatus over a network, and the server apparatus receives the user information transmitted from the image forming apparatus, based on which information:

the user identifying section identifies a user making use of the application by remote control via a remote operation host apparatus identified by the remote operation host apparatus identifying section, and

the automatic setting section initializes the remote operation host apparatus with custom setting associated with the user identified.

According to the invention, when the remote operating section of the image forming apparatus activates the application on the server apparatus by remote control, the image forming apparatus transmits the user information of the user authenticated by the authentication section, to the server apparatus over the network. And in the server apparatus, the user information transmitted thereto from the image forming apparatus is used by the user identifying section to identify a user making use of the application via the remote operation host apparatus identified by the remote operation host apparatus identifying section, and the automatic setting section initializes the remote operation host apparatus with custom setting associated with the user identified. The user making use of the link system therefore does not need to conduct such operation for each use as to select an image forming apparatus which is to be used for printing by the application and initialize the image forming apparatus with custom setting, thus allowing for further enhancement in convenience.

The invention provides a link system in which a server apparatus is linked with a client apparatus connected to an image forming apparatus so as to enable data communication over a network,

the client apparatus having a remote operating section adapted to make an application on the server apparatus available by remote control, and

the server apparatus having:

a remote operation host apparatus identifying section for identifying a remote operation host apparatus that is an image forming apparatus which is currently performing a remote operation, with the remote operating section, among the plurality of image forming apparatuses connected over a network; and.

an automatic setting section for automatically setting an image forming apparatus to be used for printing a print job of an application,

wherein when the remote operating section of the client apparatus starts an application on the server apparatus by remote control,

the client apparatus transmits an operation start signal indicative of onset of the remote control to the server apparatus over a network, and

the server apparatus receives the operation start signal transmitted from the client apparatus, based on which signal:

the remote operation host apparatus section identifies as a remote operation host apparatus the client apparatus having transmitted the operation start signal; and

based on an identification result of the remote operation host apparatus identifying section, the automatic setting section automatically sets, as the image forming apparatus directly connected to the remote operation host apparatus, an image forming apparatus to be used for printing by the application.

According to the invention, when the remote operating section of the client apparatus connected to the image forming apparatus activates the application of the server apparatus by remote control, the client apparatus transmits the operation start signal indicative of onset of the remote control. And in the server apparatus, the operation start signal transmitted thereto from the client apparatus is used by the remote operation host apparatus identifying section to identify as the remote operation host apparatus the client apparatus which has transmitted the operation start signal, and on the basis of an identification result of the remote operation host apparatus identifying section, the automatic setting section automatically sets as the image forming apparatus directly connected to the remote operation host apparatus the image forming apparatus which is to be used for printing by the application. A user making use of the link system therefore does not need to conduct such operation for each use as to select and set an image forming apparatus which is to be used for printing by the application, thus allowing for enhancement in convenience.

In the invention, it is preferable that the client apparatus has a memory section for storing user information registered in advance for each user making use of the client apparatus, and an authentication section for identifying and authenticating a user based on the user information stored in the memory section, and

the server apparatus has a user identifying section for identifying a user making use of an application by remote control, and a memory section for storing custom setting registered in advance for each user making use of the application by remote control,

wherein when the remote operating section of the client apparatus starts an application on the server apparatus by remote control,

the client apparatus transmits user information of a user authenticated by the authentication section, to the server apparatus over a network, and

the server apparatus receives the user information transmitted from the client apparatus, based on which information:

the user identifying section identifies a user making use of the application by remote control via a remote operation host apparatus identified by the remote operation host apparatus identifying section, and

the automatic setting section initializes an image forming apparatus directly connected to the remote operation host apparatus, with custom setting associated with the user identified.

According to the invention, when the remote operating section of the client apparatus activates the application on the server apparatus by remote control, the client apparatus transmits the user information of the user authenticated by the authentication section, to the server apparatus over the network. And in the server apparatus, the user information transmitted thereto from the client apparatus is used by the user identifying section to identify a user making use of the application via the remote operation host apparatus identified by the remote operation host apparatus identifying section, and the automatic setting section initializes the image forming apparatus directly connected to the remote operation host apparatus, with custom setting associated with the user identified. The user making use of the link system therefore does not need to conduct such operation for each use as to select an image forming apparatus which is to be used for printing by the application, and initialize the image forming apparatus with custom setting, thus allowing for further enhancement in convenience.

In the invention, it is preferable that the application on the server apparatus is a PC desktop application with a graphical user interface (GUI) included, and

the remote operating section of the image forming apparatus or the client apparatus is adapted to make the GUI provided in the application on the server apparatus available by remote control.

According to the invention, the application on the server apparatus is a GUI-containing PC desktop application. And the image forming apparatus or the client apparatus is so adapted that the remote operating section therein enables the remote control of the GUI provided in the application on the server apparatus. The image forming apparatus or the client apparatus is thus able to give a command for starting the application by use of the GUI. In addition, owing to the fact that the application activated by remote control is a desktop application, it is possible to maintain higher security than the case of Web application.

In the invention, it is preferable that the server apparatus has an image forming apparatus driver for controlling the image forming apparatus, and

the server apparatus uses the image forming apparatus driver to control communication required for image formation and control the image forming apparatus serving as the remote operation host apparatus, or the image forming apparatus directly connected to the client apparatus serving as the remote operation host apparatus.

According to the invention, the server apparatus has the image forming apparatus driver for controlling the image forming apparatus. And with use of the image forming apparatus driver, the server apparatus is capable of controlling the communication required for image formation in the image forming apparatus serving as the remote operation host apparatus, or the image forming apparatus directly connected to the client apparatus serving as the remote operation host apparatus.

In the invention, it is preferable that the server apparatus is connected to the image forming apparatus or the client apparatus by a Web service application program interface (API), and

the server apparatus uses the Web service API to control communication required for image formation and control the image forming apparatus serving as the remote operation host apparatus, or the image forming apparatus directly connected to the client apparatus serving as the remote operation host apparatus.

According to the invention, the server apparatus is connected to the image forming apparatus or the client apparatus by the Web service API. And with use of the Web service API, the server apparatus controls the image forming apparatus serving as the remote operation host apparatus, or the image forming apparatus directly connected to the client apparatus serving as the remote operation host apparatus.

In the invention, it is preferable that the server apparatus has a plurality of applications, and each of the applications is exclusively used by one of the plurality of image forming apparatuses or client apparatuses serving as the remote operation host apparatuses.

According to the invention, the server apparatus has the plurality of applications. And each of the applications is exclusively used by one of the plurality of image forming apparatuses or client apparatuses serving as the remote operation host apparatuses. This allows one application to be activated concurrently by a plurality of remote operation host apparatuses even in the case where the remote operating sections of a plurality of remote operation host apparatuses start one application.

In the invention, it is preferable that the server apparatus has a plurality of applications,

the plurality of image forming apparatuses or client apparatuses have the remote operating sections adapted to enable multitasking for separate remote control activation of one application among the plurality of applications provided in the server apparatus, and

the server apparatus correlates as the remote operation host apparatus the image forming apparatuses or client apparatuses which have separately started the application by multitasking.

According to the invention, the server apparatus has the plurality of applications, and the plurality of image forming apparatuses or client apparatuses are so adapted that the remote operating sections therein are capable of multitasking, that is, separately starting one application by remote control among the plurality of applications provided in the server apparatus. And the server apparatus correlates as the remote operation host apparatuses the image forming apparatuses or client apparatuses which have separately started the application by multitasking. This allows one application to be activated concurrently by a plurality of remote operation host apparatuses even in the case where the remote operating sections of a plurality of remote operation host apparatuses start one application.

In the invention, it is preferable that the server apparatus has a plurality of applications,

the plurality of image forming apparatuses or client apparatuses have the remote operating sections adapted to enable multitasking for separate remote control activation of one application among the plurality of applications provided in the server apparatus, and

the server apparatus receives the user information transmitted from the image forming apparatus or client apparatus, based on which information:

the user identifying section identifies a user making use of the application by remote control via a remote operation host apparatus identified by the remote operation host apparatus identifying section, and

the automatic setting section initializes the remote operation host apparatus with custom setting associated with the user identified.

According to the invention, the server apparatus has the plurality of applications, and the plurality of image forming apparatuses or client apparatuses are so adapted that the remote operating sections therein are capable of multitasking, that is, separately starting one application by remote control among the plurality of applications provided in the server apparatus. And in the server apparatus, the user information transmitted thereto from the image forming apparatus or client apparatus is used by the user identifying section to identify a user making use of the application via the remote operation host apparatus identified by the remote operation host apparatus identifying section, and the automatic setting section initialize the remote operation host apparatus with custom setting associated with the user identified. This allows one application to be activated concurrently by a plurality of remote operation host apparatuses even in the case where the remote operating sections of plural remote operation host apparatuses start one application, and moreover the custom setting for each user can be set by default.

In the invention, it is preferable that a communication protocol for use in the user identifying section is a hyper text transfer protocol (HTTP), and an HTTP request message includes the user information.

According to the invention, the communication protocol for use in the user identifying section is HTTP. The HTTP request message can therefore be adapted to contain the user information.

In the invention, it is preferable that the communication protocol for use in the user identifying section is a simple object access protocol (SOAP), and an SOAP request massage includes the user information.

According to the invention, the communication protocol for use in the user identifying section is SOAP. The SOAP request message can therefore be adapted to contain the user information.

In the invention, it is preferable that the image forming apparatus or the client apparatus has a setting switching section for switching to an operational mode that manual setting is allowed so as to enable setting of the image forming apparatus to be used for printing by the application, by arbitrary selection from the image forming apparatuses connected over a network.

According to the invention, the image forming apparatus or the client apparatus has a setting switching section for switching modes to the operational mode that manual setting is allowed to select and set any of the image forming apparatuses connected over the network as the image forming apparatus or client apparatus which is to be used for printing by the application. As a result, in setting an apparatus other than the remote operation host apparatus as the image forming apparatus or client apparatus to be used for printing by the application, the setting switching section switches modes and thereby sets the operational mode to enable manual setting of the apparatus at will.

In the invention, it is preferable that when the server apparatus controls a given image forming apparatus manually set as the image forming apparatus to be used for printing by the application, in the operational mode set by the setting switching section in the image forming apparatus or client apparatus,

the server apparatus starts the control after a predetermined time has elapsed since reception of the operation start signal.

According to the invention, in the image forming apparatus or client apparatus, the setting switching section switches modes and thereby sets the operational mode that the image forming apparatus or client apparatus to be used for printing by the application is manually set at will and then, the server apparatus which is to control the given image forming apparatus manually set, starts the control after a predetermined length of time has elapsed since reception of the operation start signal. This allows the user making use of the link system to start the use of the application after a lapse of the predetermined time. It is thus possible to prevent a third party from using the application without permission before the lapse of the predetermined time.

In the invention, it is preferable that when the server apparatus controls a given image forming apparatus manually set as the image forming apparatus to be used for printing by the application, in the operational mode set by the setting switching section in the image forming apparatus or client apparatus,

the server apparatus starts the control at a predetermined time point.

According to the invention, in the image forming apparatus or client apparatus, the setting switching section switches modes and thereby sets the operational mode that the image forming apparatus or client apparatus to be used for printing by the application is manually set at will and then, the server apparatus which is to control the given image forming apparatus manually set, starts the control at the predetermined time point. This allows the user making use of the link system to start the use of the application at the predetermined time point. It is thus possible to prevent a third party from using the application without permission before the predetermined time point.

In the invention, it is preferable that when the server apparatus controls a given image forming apparatus manually set as the image forming apparatus to be used for printing by the application, in the operational mode set by the setting switching section in the image forming apparatus,

the server apparatus starts the control after a command indicative of onset of the control is entered on an input section of the given image forming apparatus manually set.

According to the invention, in the image forming apparatus or client apparatus, the setting switching section switches modes and thereby sets the operational mode that the image forming apparatus to be used for printing by the application is manually set and then, the server apparatus which is to control the given image forming apparatus manually set, starts the control after the command indicative of onset of the control is entered on the input section of the given image forming apparatus manually set. This allows the user making use of the link system to start the use of the application based on the command entered on the input section in the given image forming apparatus manually set. It is thus possible to prevent a third party from using the application without permission.

In the invention, it is preferable that when the server apparatus controls a given image forming apparatus manually set as the image forming apparatus to be used for printing by the application, in the operational mode set by the setting switching section in the client apparatus,

the server apparatus starts the control after a command indicative of onset of the control is entered on an input section of a client apparatus connected to the given image forming apparatus manually set.

According to the invention, in the client apparatus, the setting switching section switches modes and thereby sets the operational mode that the image forming apparatus to be used for printing by the application is manually set and then, the server apparatus which is to control the given image forming apparatus manually set, starts the control after the command indicative of onset of the control is entered on the input section of the given image forming apparatus manually set. This allows the user making use of the link system to start the use of the application based on the command entered on the input section in the given image forming apparatus manually set. It is thus possible to prevent a third party from using the application without permission.

### BRIEF DESCRIPTION OF THE DRAWINGS

Other and further objects, features, and advantages of the invention will be more explicit from the following detailed description taken with reference to the drawings wherein:

FIG. 1 is a block diagram showing a configuration of a link system according to a first embodiment of the invention;

FIG. 2 is a view showing one example of user information;

FIG. 3 is a view showing a basic sequence in the link system;

FIGS. 4A and 4B are flowcharts each showing a flow of operation in the link system;

FIG. 5 is a flowchart showing a flow of operation in a manual mode in the link system;

FIG. 6 is a view showing one example of an HTTP request message in form of HTTP POST;

FIG. 7 is a view showing one example of an SOAP request envelop in form of SOAP message;

FIG. 8 is a view showing one example of a UI screen appearing on a display section of MFP during a remote operation;

FIG. 9 is a view showing association between IP addresses and device driver names;

FIG. 10 is a view showing association of custom setting for each login user;

FIG. 11 is a view showing one example of a standard dialog appearing on the display section of MFP while the remote operation is not performed; and

FIG. 12 is a block diagram showing a configuration of a link system according to a second embodiment of the invention.

### DETAILED DESCRIPTION

Now referring to the drawings, preferred embodiments of the invention are described below.

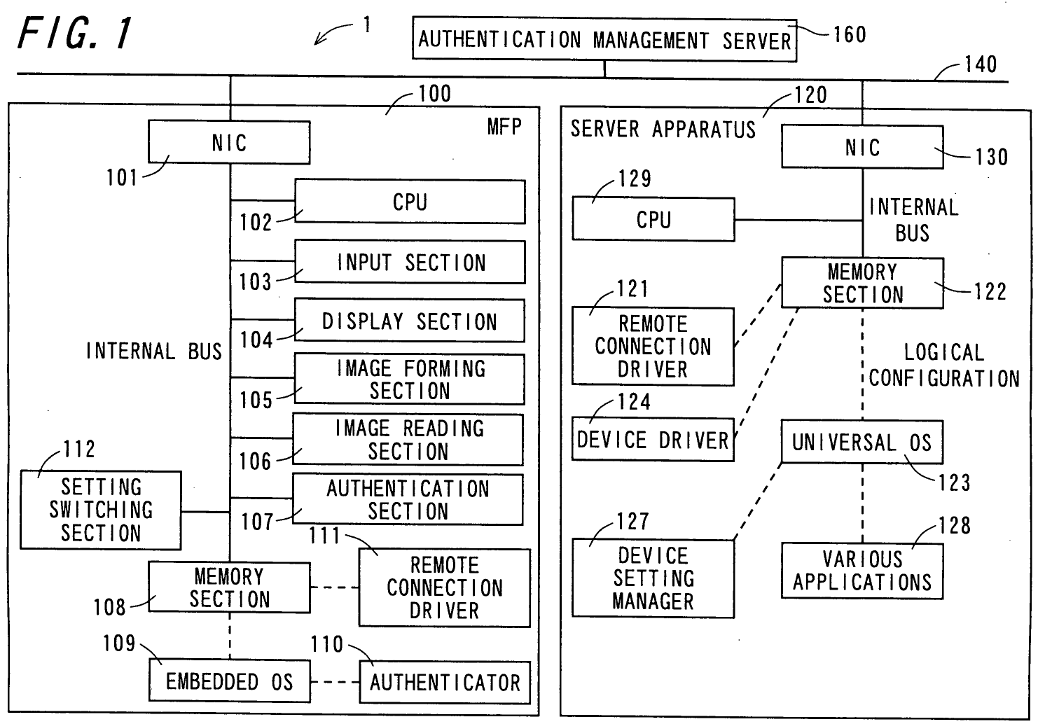

FIG. 1 is a block diagram showing a configuration of a link system 1 according to a first embodiment of the invention. The link system 1 is a system in which a server apparatus 120 is connected with a plurality of image forming apparatuses such as multifunction printers (abbreviated as MFP) 100, so as to enable data communication over a network 140, and that automatically sets an MFP 100 which is to be used for printing a print job of an application on the server apparatus 120. The network 140 is a local area network (abbreviated as LAN) constituted by, for example, ETHERNET (registered trademark).

The MFP 100 is an apparatus which prints on a recording medium such as a recording sheet the print data that is created by using the application on the server apparatus 120 and then transmitted to the MFP 100 over the network 140. The MFP 100 includes a network interface card (abbreviated as NIC) 101, a central processing unit (abbreviated as CPU) 102, an input section 103, a display section 104, an image forming section 105, an image reading section 106, an authentication section 107, a memory section 108, and a remote connection driver 111.

The NIC 101 is an interface card which is incorporated in the MFP 100 and thereby connected to the network 140. The MFP 100 is so adapted to make data communication through the NIC 101.

The input section 103 is a component for operating the MFP 100 itself as well as operating an application on the later-described server apparatus 120 by remote control. The input section 103 includes not only a hardware button but also a touch panel, a mouse, a tablet, and the like component.

The display section 104 is a component for displaying a status of the MFP 100 itself as well as displaying a user interface (abbreviated as UI) of an application on the server apparatus 120 operated by remote control. Examples of the display section 104 include a flat panel display (abbreviated as FPD) such as a liquid crystal display (abbreviated as LCD), a plasma display panel (abbreviated as PDP), and a surface conduction electron emitter display (abbreviated as SED). In the present embodiment, an LCD having a resolution equal to or higher than video graphics array (abbreviated as VGA) is adopted as the display section 104, considering that a graphic user interface (abbreviated as GUI) screen of a PC desktop application is displayed by remotely operating the application on the later-described server apparatus 120. Note that even a display section 140 having a resolution lower than VGA is capable of converting its display to an optimum display through a heretofore known technique.

The image reading section 106 is a component for reading the print data to be printed on a recording medium. The image forming section 105 is a component for providing a print by forming an image on a recording medium based on the print data transmitted from the server apparatus 120 or the print data read by the image reading section 106. The authentication section 107 authenticates a user who has entered a command on the input section 103. The authentication section 107 has, for example, a fingerprint authenticating portion to authenticate a fingerprint of a user entering a command on the input section 103 by comparison with fingerprint data contained in user information previously stored in the later-described memory section 108.

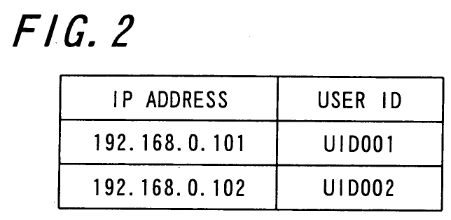

The memory section 108 previously registers and thereby stores user information for each user making use of the MFP 100. Now, FIG. 2 is a view showing one example of the user information. The user information is information which is given to each user and thus capable of specifying the user individually. In an alternate configuration, such user information may be collectively managed by an external server, namely, an authentication management server 160. The user information contains, for example, an Internet protocol (abbreviated as IP) address and a user identification (abbreviated as ID) as shown in FIG. 2. In addition, the memory section 108 stores an embedded operating system (abbreviated as OS) 109 represented by VxWorks (registered trademark). In the embedded OS 109, an authenticator 110 for conducting user authentication of the user making use of the MFP 100 is incorporated. The MFP 100 is activated based on the embedded OS 109, uses the authenticator 110 to conduct the user authentication of the user entering a command on the input section 103 in reference to the user information, and grants the user permission to make appropriate access authorization setting, custom setting, or the like setting.

The remote connection driver 111 is incorporated in the MFP 100 and controls the communication required for remote operation in the MFP 100. The remote connection driver 111 serves as a remote operating section which is adapted to make the application on the server apparatus 120 available by remote control. The CPU 102 collectively controls the respective components and drivers, etc.

The server apparatus 120 is a computer which provides the plurality of MFPs 100 connected over the network 140 with functions or data stored in the server apparatus 120 itself. The server apparatus 120 includes a remote control driver 121, a memory section 122, a device driver 124, a device setting manager 127, a CPU 129 and an NIC 130. The NIC 130 is an interface card which is incorporated in the server apparatus 120 for the purpose of creating connection to the network 140. The server apparatus 120 is so adapted to make data communication through the NIC 130.

The device driver 124 is software which is adapted to be capable of controlling and operating the MFP 100. The device setting manager 127 is a module having a function of managing association between a remote operation host apparatus, i.e., an MFP 100 which uses an application on the server apparatus 120 by remote control, and the device driver 124 available to operate the remote operation host apparatus, as well as a function of setting parameters in the device driver 124. In the present embodiment, the device setting manager 127 is software installed in the server apparatus 120, for which any installation method may be adopted. The device setting manager 127 serves also as: a remote operation host apparatus identifying section for identifying a remote operation host apparatus that is an MFP 100 which uses an application on the server apparatus 120 by remote control; an automatic setting section that, based on an identification result, automatically sets as the remote operation host apparatus the MFP 100 which uses the application by remote control; and an user identifying section that, based on user information, identifies a user who operates the remote operation host apparatus to use the application by remote control.

The memory section 122 of the server apparatus 120 stores a universal OS 123 represented by WINDOWS (registered trademark). The server apparatus 120 is activated based on the universal OS 123. In the universal OS 123, a plurality of various applications 128 are incorporated. In the present embodiment, the various applications 128 are, to be specific, PC desktop applications with GUI included. Moreover, the memory section 122 stores custom settings registered in advance, which relate to respective user information transmitted from the MFPs 100 and are to be used in starting the applications.

The remote connection driver 121 is incorporated in the server apparatus 120 and controls' the communication required for remote operation in the server apparatus 120. The CPU 129 collectively controls the respective components and drivers, etc.

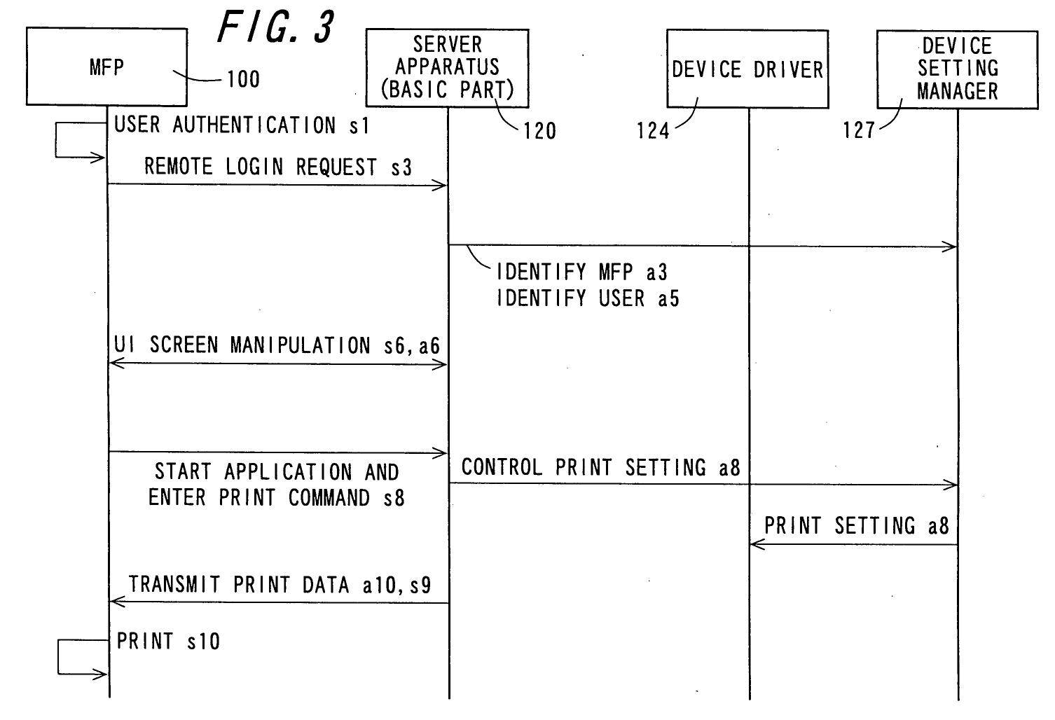

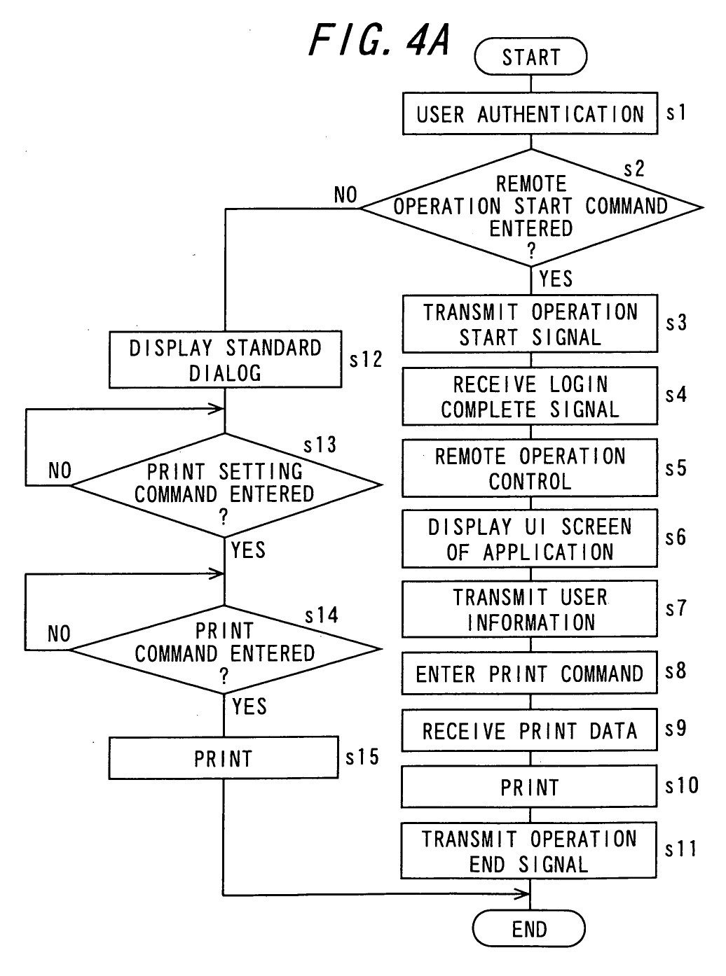

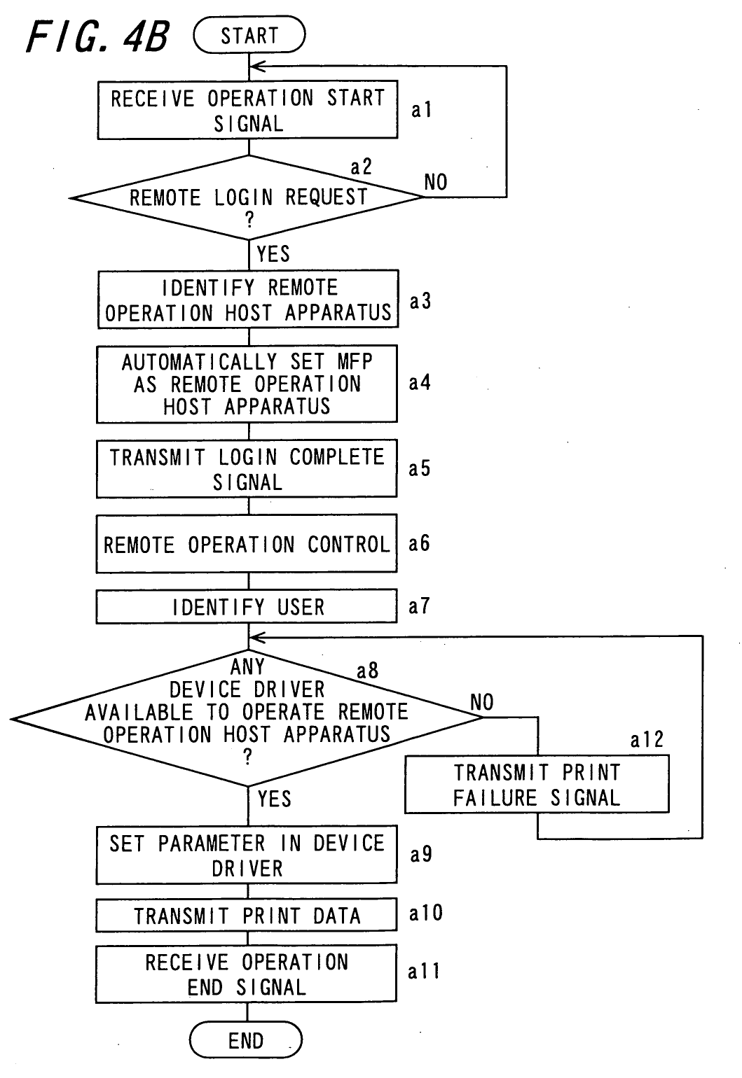

FIG. 3.is a view showing a basic sequence in the link system 1. FIGS. 4A and 4B are flowcharts each showing a flow of operation in the link system 1. FIG. 4A is a flowchart showing a flow of operation in the MFP 100 while FIG. 4B is a flowchart showing a flow of operation in the server apparatus 120. And FIG. 5 is a flowchart showing a flow of operation in a manual mode in the link system 1.

Referring to FIG. 4A, a process for a user to make use of the link system 1 will be explained. Firstly, in Step s1, the CPU 102 of the MFP 100 conducts the user authentication in reference to the user information based on the authenticator 110 incorporated in the embedded OS 109, and then grants the user permission to make appropriate access authorization setting, custom setting, or the like setting, thereby controlling the MFP 100 to allow the user to log into the MFP 100. Next, in Step s2, the CPU 102 of the MFP 100 determines whether or not a remote operation start command indicative of onset of the remote control has been entered on the input section 103. If the CPU 102 determines that the remote operation start command has been entered, the process proceeds to Step s3, and if the CPU 102 determines that the remote operation start command has not been entered, the process proceeds to Step s12.

In Step s3, CPU 102 of MFP 100 controls the remote connection driver 111 to transmit an operation start signal indicative of onset of the remote control to the server apparatus 120 through the NIC 101 and requests for remote login to the server apparatus 120. Note that in the present embodiment, the application 128 on the server apparatus 120 is a PC desktop application with GUI included, and in the case where the application on the server apparatus 120 is a Web application, the above remote login operation will not be performed but the Web application will run directly.

Referring to FIG. 4B, in Step a1, the CPU 129 of the server apparatus 120 receives the operation start signal which has been transmitted through the NIC 101 from the MFP 100 in Step s3, and the process proceeds to Step a2. In Step a2, the CPU 129 of the server apparatus 120 controls the remote connection driver 121 to determine whether or not the signal received is a signal of indicative of request for remote login. If the remote connection driver 121 of the server apparatus 120 determines that the signal received is the signal of indicative of request for remote login, the process proceeds to Step a3, and if the remote connection driver 121 determines that the signal received is not the signal of indicative of request for remote login, the process returns to Step a1.

In Step a3, the server apparatus 120 executes remote processing of logging into the server apparatus 120. To be specific, the CPU 129 of the server apparatus 120 firstly controls the device setting manager 127 to identify the remote operation host apparatus that is the MFP 100 which uses the application 128 on the server apparatus 120 by remote control, and the process proceeds to Step a4. In Step a4, the CPU 129 of the server apparatus 120 controls the device setting manager 127 to automatically set the MFP 100 identified in Step a3 as the remote operation host apparatus. A user making use of the link system 1 therefore does not need to conduct such operation for each use as to select and set an image forming apparatus which is to be used for printing by the application, thus allowing for enhancement in convenience.

Next, in Step a5, the CPU 129 of the server apparatus 120 controls the remote connection driver 121 to transmit a login complete signal indicative of completion of the remote login processing to the MFP 100 through the NIC 130, and the process proceeds to Step a6. In Step a6, the CPU 129 of the server apparatus 120 controls the remote connection driver 121 to control the communication required for remote operation.

Referring to FIG. 4A, in Step s4, the CPU 102 of the MFP 100 receives through the NIC 101 the login completion signal which has been transmitted by the server apparatus 120 in Step a5, and the process proceeds to Step s5. In Step s5, the CPU 102 of the MFP 100 controls the remote connection driver 111 to control the communication required for remote operation. The remote control is thus carried out from the MFP 100 so as to allow the universal OS 123 and the various applications 128 on the server apparatus 120 to be used, and in this state, the process proceeds to Step s6.

At the time, the link system 1 is so adapted that each of the plurality of applications 128 installed in the server apparatus 120 is exclusively used by one of the plurality of MFPs 100 connected to the server apparatus 120. For example, the MFP 100 is adapted to enable multitasking for separate remote control activation of one application among the plurality of applications 128 installed in the server apparatus 120. And the server apparatus 120 correlates as the remote operation host apparatuses the MFPs 100 which have separately started the application by multitasking. To be specific, in the case where the application 128 installed in the server apparatus 120 is a Web application, a concept of session is used to allow the MFP 100 to exclusively use each of the plurality of applications 128 installed in the server apparatus 120 by remote control. Further, in the case where the application 128 installed in the server apparatus 120 is a desktop application, a plurality of application processes are executed on the server apparatus 120 or common modules are placed in advance in a resident state so that only a necessary module containing an UI section is loaded in accordance with the request given from MFP 100.

In Step s6, the CPU 102 of the MFP 100 controls the display section 104 to show a UI screen of the application 128 provided on the server apparatus 120. In the MFP 100 ready for remote control, the input section 103 can be used to manipulate the UI screen shown by the display section 104. Next, in Step s7, the CPU 102 of the MFP 100 controls the remote connection driver 111 to transmit user information and device identification information of the MFP 100 itself through the NIC 101. By so doing, the MFP 100 can use the application 128 on the server apparatus 120 by remote control, independently from other users.

Referring to FIG. 4B, in Step a7, the CPU 129 of the server apparatus 120 receives through the NIC 130 the user information and the device identification information which have been transmitted from the MFP 100 in Step s7. And the CPU 129 of the server apparatus 12 controls the device setting manager 127 to identify the MFP 100 and a user operating the MFP 100 based on the device identification information and the user information. The server apparatus 120 thus specifies the MFP 100 which is to be subjected to the remote operation session, as well as the user who operates the MFP 100, among the plurality of MFPs connected to the network 140. At this time, the memory section 122 stores session information of the remote operation session.

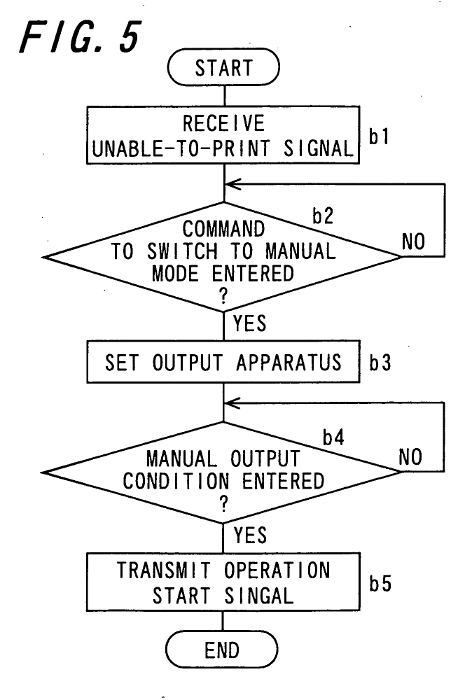

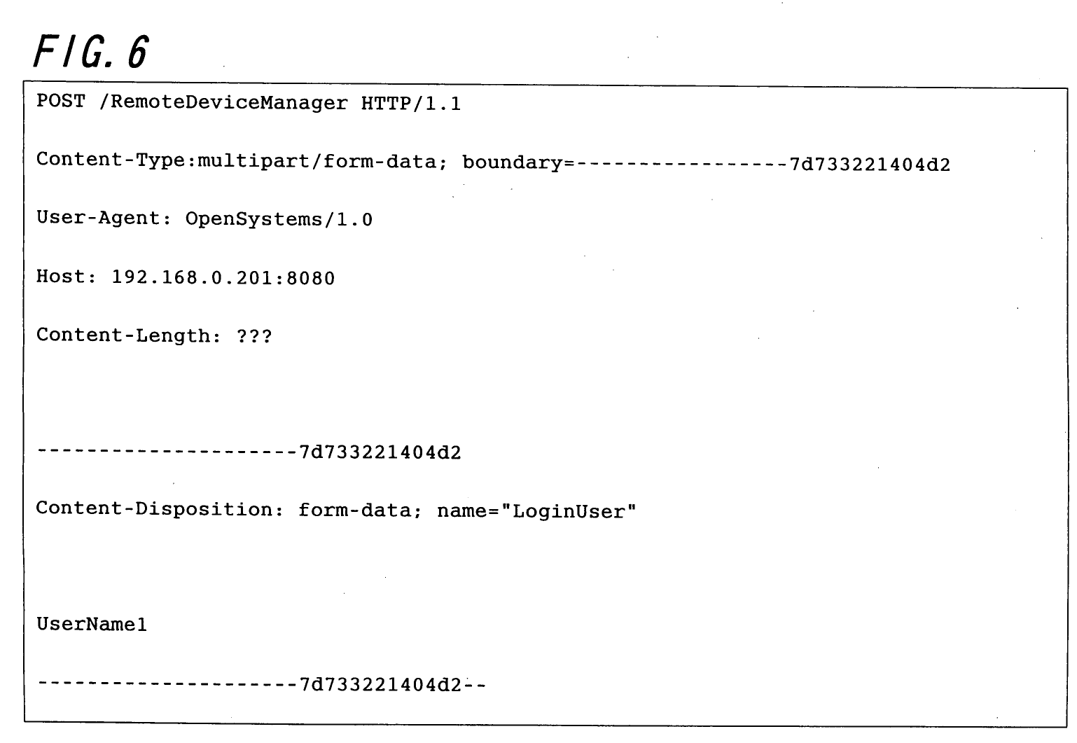

Now, the communication protocol for use in the device setting manager 127 is preferably a hyper text transfer protocol (abbreviated as HTTP) or a simple object access protocol (abbreviated as SOAP). In the case where the communication protocol is the HTTP or the SOAP, the user information to be transmitted from the MFP 100 in Step s7 is as follows. FIG. 6 is a view showing one example of an HTTP request message in form of HTTP POST. And FIG. 7 is a view showing one example of an SOAP request envelop in form of SOAP message.

The user information to be transmitted from the MFP 100 is contained in the HTTP request message as shown in FIG. 6 in the case where the communication protocol is the HTTP. This allows the Web application of the server apparatus 120 to easily analyze and acquire the user information. Further, in the case where the communication protocol is the SOAP, the user information to be transmitted from the MFP 100 is contained in the SOAP request envelope as shown in FIG. 7. This allows the Web application of the server apparatus 120 to easily analyze and acquire the use information. And in either case where the communication protocol is the HTTP or the SOAP, it is possible to reduce the number of steps for development of such system construction as to analyze the user information.

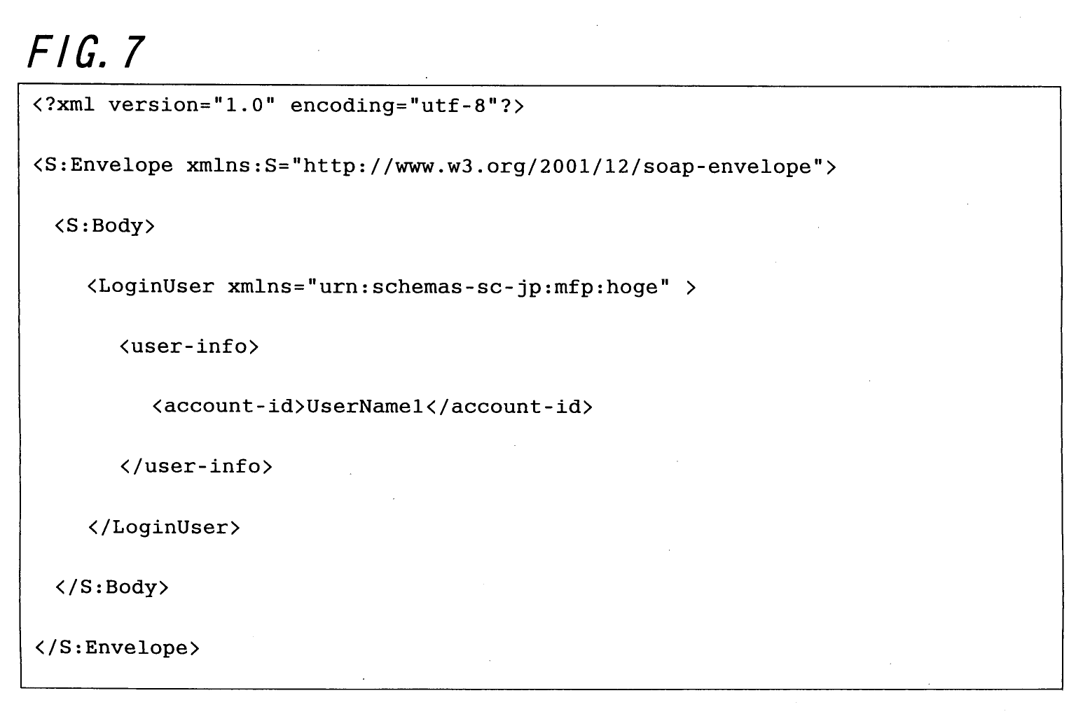

Referring to FIG. 4A, in the following Step s8, a print command is entered on the input section 103 of the MFP 100 in the case where the user operates the MFP 100 to remotely operate the application 128 on the server apparatus 120 and thereby prints the print data. Now, the print command is entered as follows. FIG. 8 is a view showing one example of the UI screen appearing on the display section 104 of the MFP 100 during the remote operation. The MFP 100 ready for remote control can operate the application 128 provided on the server apparatus 120, by manipulating a print button or the like arranged on the UI screen shown by the display section 104. In the MFP 100, the print button arranged on the UI screen shown by the display section 104 is pressed down by means of the input section 103 such as a touch panel and a mouse, with the result that the print command is entered.

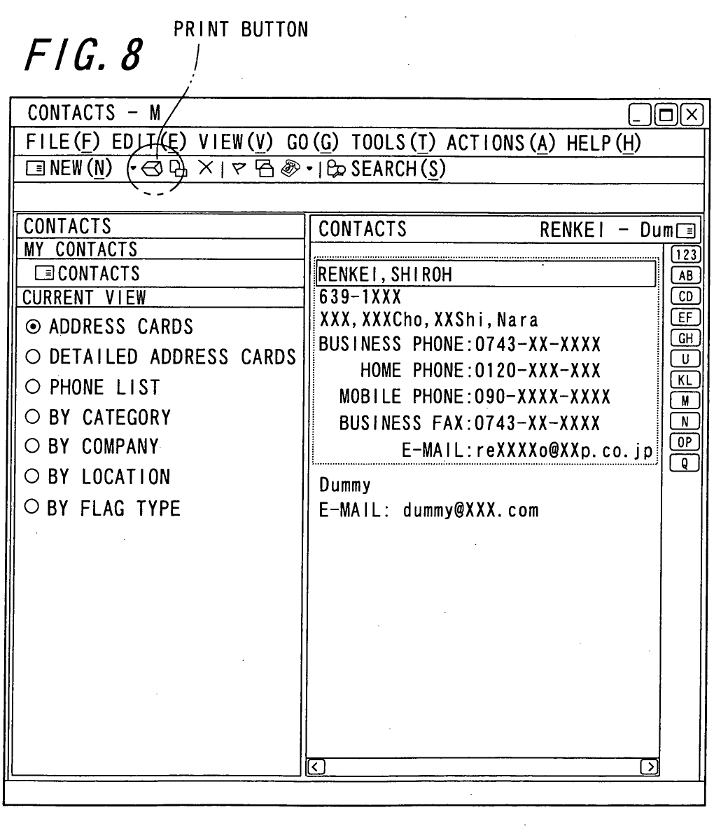

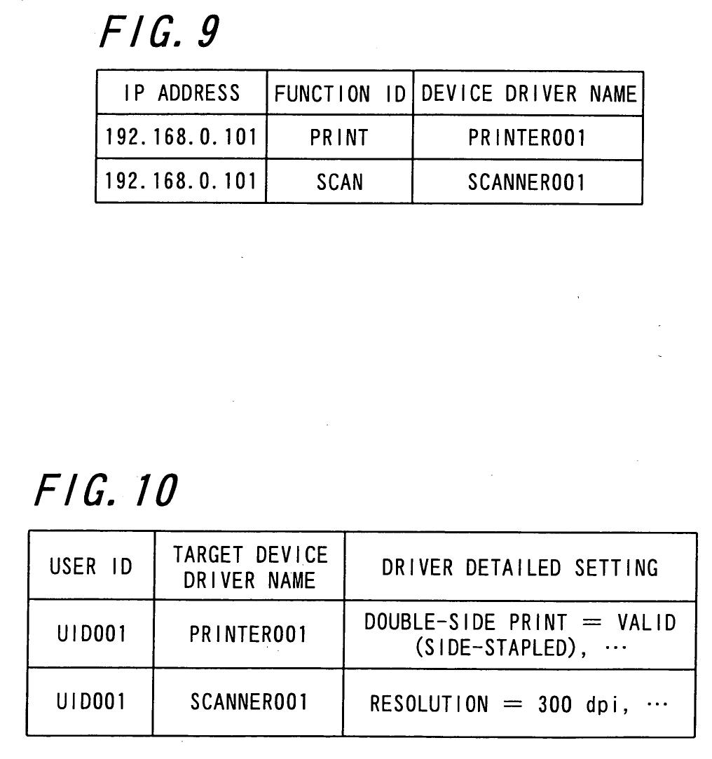

Referring to FIG. 4B, in Step a8, the CPU 129 of the server apparatus 120 refers to the print command entered to the MFP 100 in Step s8 and controls the device setting manager 127 to determine whether or not there is any device driver 124 available for the MFP 100 serving as the remote operation host apparatus. Now, FIG. 9 is a view showing association between IP addresses and device driver names. And FIG. 10 is a view showing association of custom setting for each login user. The device setting manager 127 specifies the device driver 124 available for the MFP 100 by using: correspondence information of the IP addresses and device driver names previously registered and thus stored in the memory section 122; information such as custom setting for each user ID, which associates the MFP 100 with the device driver 124; and the user information. If the device setting manager 127 determines that there is a device driver 124 available for the MFP 100, the process proceeds to Step a9, and if the device setting manager 127 determines that there is no device driver 124 available for the MFP 100, the process proceeds to Step a12.

In Step a9, the CPU 129 of the server apparatus 120 controls the device setting manager 127 to set parameters in the device driver 124. Next, in Step a10, the CPU 129 of the server apparatus 120 controls the device driver 124 to transmit print data.

Referring to FIG. 4A, in the following Step s9, the CPU 102 of the MFP 100 receives through the NIC 101 the print data which has been transmitted from the server apparatus 120 in Step a10, and the process proceeds to Step s10. In Step s10, the CPU 102 of the MFP 100 controls the image forming section 105 to form the print data on a recording medium and then output a print. The MFP 100 is thus capable of printing on a recording medium the print data that is created by using the application 128 on the server apparatus 120 and then transmitted to the MFP 100 over the network 140. At this time, the CPU 102 of the MFP 100 may control the image reading section 106 such as a scanner to read the print data.

Note that in order to end the remote operation in the link system 1, an operation end signal indicative of end of the remote operation is transmitted from the MFP 100 in Step s11. And then, referring to FIG. 4B, the server apparatus 120 receives the operation end signal in Step a11, whereby the remote operation ends in the link system 1.

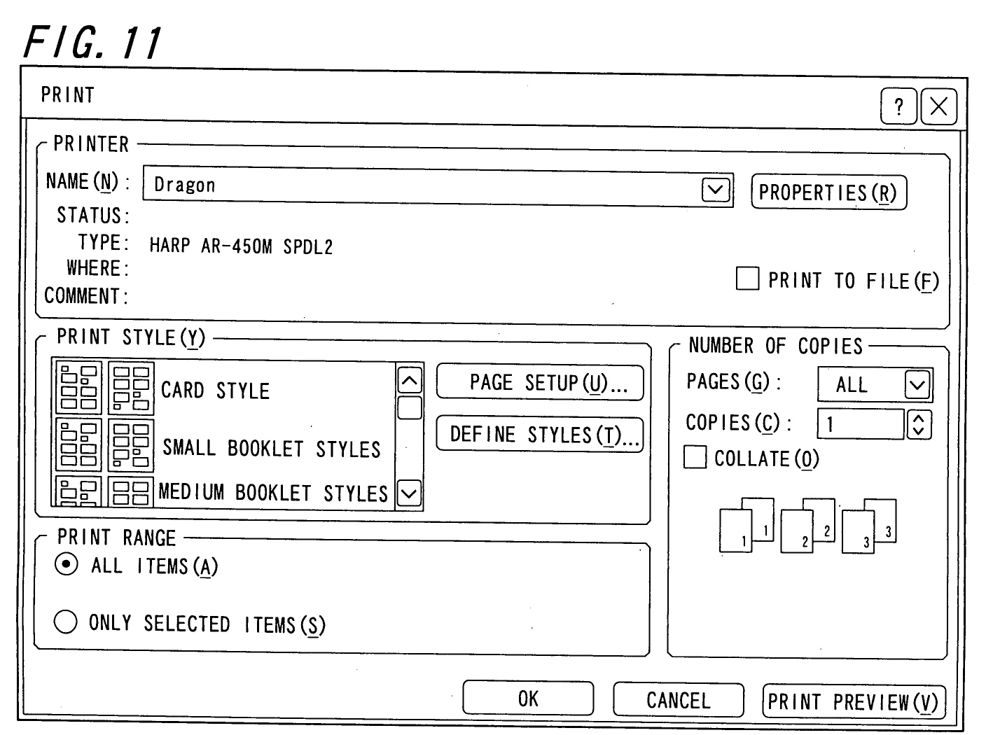

Further, if the CPU 102 of the MFP 100 determines in Step s2 of FIG. 4A, that the remote operation start command has not been entered, the proceeds to Step s12. In Step s12, the CPU 102 of the MFP 100 is activated based on the embedded OS 109. Now, FIG. 11 is a view showing one example of a standard dialog appearing on the display section 104 of the MFP 100 while the remote operation is not performed. In the MFP 100 activated based on the embedded OS 109, a standard dialog as shown in FIG. 11 appears on the display section 104. Next, in Step s13, the CPU 102 of the MFP 100 determines whether or not any command regarding print setting has been entered on the input section 103. If the CPU 102 determines that the print setting command has been entered, the process proceeds to Step s14, and if the CPU 102 determines that the print setting command has not been entered, Step s13 is repeated. Next, in Step s14, the CPU 102 of the MFP 100 determines whether or not a command regarding printing has been entered on the input section 3. If the CPU 102 determines that the print command has been entered, the process proceeds to Step s15, and if the CPU 102 determines that the print command has not been entered, Step s14 is repeated. And in Step s15, the CPU 102 of the MFP 100 controls the image forming section 105 to form the print data on a recording medium and then output a print.

Further, if the device setting manager 127 of the server apparatus 120 determines in Step a8 of FIG. 4B, that there is no device driver 124 available for the MFP 100, the proceeds to Step a12. In Step a12, the CPU 129 of the server apparatus 120 controls the remote connection driver 121 to transmit an unable-to-print signal indicating that it is impossible to transmit print data.

In the link system 1, the MFP 100 includes a setting switching section 112 for switching modes to a manual mode that the MFP for outputting the print data can be manually set, in order to enable any one of the MFPs connected over the network to output the print data created by using the application 128 provided on the server apparatus 120 by remote control, for example, when the server apparatus 120 has no device drivers available for the MFP 100. As shown in FIG. 5, in Step b1, the MFP 100 receives the unable-to-print signal transmitted from the server apparatus 120.

Next, in Step b2, the CPU 102 of the MFP 100 determines whether or not a command to switch modes to the manual mode has been entered on the input section 103. If the CPU 102 determines that the command to switch modes to the manual mode has been entered, the process proceeds to Step b3, and if the CPU 102 determines that the command to switch modes to the manual mode has not been entered, Step b2 is repeated. In Step b3, on the basis of the command entered on the input section 103, the CPU 102 of the MFP 100 controls the setting switching section to switch modes to the manual mode and sets any MFP other than MFP 100 as the remote operation host apparatus that will be an output apparatus from which the print data is outputted by remote control.

Next, in Step b4, the CPU 102 of the MFP 100 determines whether or not a manual output condition command giving an instruction on conditions for the output apparatus to output the print data has been entered on the input section 103. If the CPU 102 determines that the manual output condition command has been entered, the process proceeds to Step b5, and if the CPU 102 determines that the manual output condition command has not been entered, Step b4 is repeated. Now, the manual output condition command is an instruction on setting of such control start conditions that the server apparatus 120 can remotely operate the output apparatus when the print data is to be outputted from the output apparatus manually set.

In Step b5, the CPU 102 of the MFP 100 controls the remote connection driver 111 to transmit an operation start signal indicating that the remote operation is to be started by the output apparatus, to the server apparatus 120 through the NIC 101.

The operation start signal is thus transmitted from the MFP 100 to the server apparatus 120, which puts the server apparatus 120 in a standby mode. And then the process proceeds to Step a8 shown in FIG. 4B, and the server apparatus 120 starts the control to enable the remote operation of the output apparatus based on the manual output condition command entered in Step b4. In the case where a command to start the control after a lapse of predetermined length of time is entered as the manual output condition command, for example, the server apparatus 120 starts the control of the output apparatus after the predetermined length of time has elapsed since reception of the operation start signal from the MFP 100, and sets the parameters in the device driver 124 available for the output apparatus as well as transmits the print data. The configuration as above can be provided by incorporating in the link 'system 1 the logic of holding for an inputted predetermined length of time before starting the control of the output apparatus.

Further, in the case where a command to start the control at a predetermined time point is entered as the manual output condition command, for example, the server apparatus 120 starts the control of the output apparatus at the predetermined time point and sets the parameters in the device driver 124 available for the output apparatus as well as transmits the print data. The configuration as above can be provided by incorporating in the link system 1 the logic of holding till the inputted predetermined time point before starting the control of the output apparatus.

This allows the user making use of the link system 1 to print the print data created by using the application 128 on the server apparatus 120, from the output apparatus after the lapse of predetermined time or at the predetermined time point. It is thus possible to prevent a third party from using the output apparatus without permission to print the print data before the lapse of predetermined time or the predetermined time point.

The server apparatus 120 may be adapted to awake from the standby mode and start the control of the output apparatus after the command indicative of onset of the control is entered on the input section such as a touch panel, of the output apparatus.

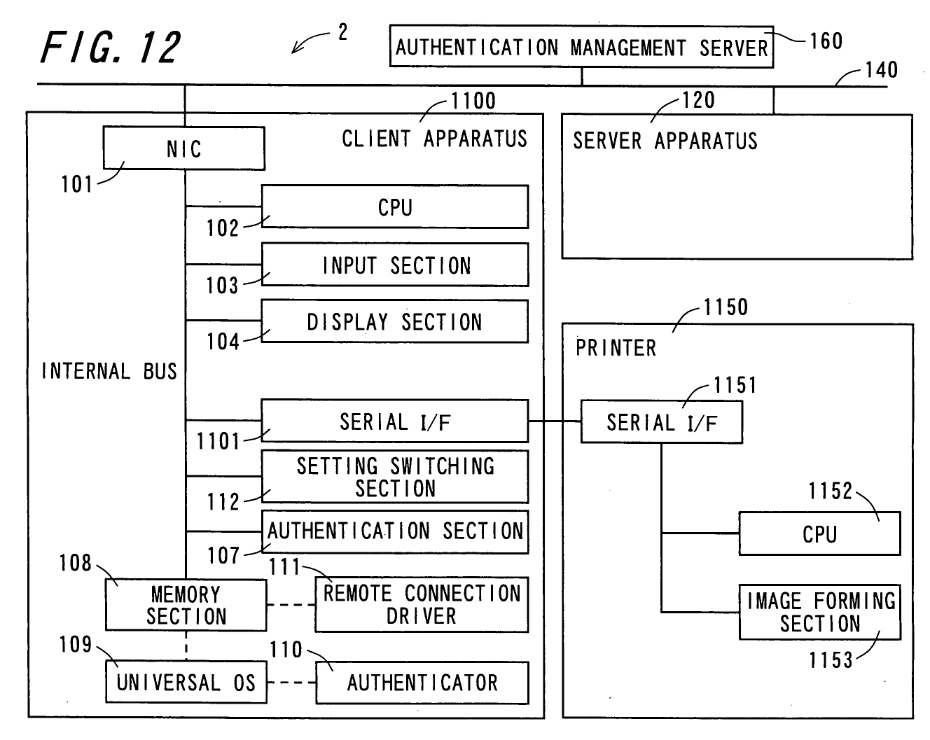

FIG. 12 is a block diagram showing a configuration of a link system 2 according to a second embodiment of the invention. The link system 2 according to the second embodiment is similar to the link system 1 according to the first embodiment and explanation will therefore not be repeated, of corresponding parts numbered with the same reference numerals. The link system 2 is a system connecting the server apparatus 120 with a plurality of personal computers (PCs) which are namely client apparatuses 1100, so as to enable data communication over the network 140, and that automatically sets an image forming apparatus, namely a printer 1150, connected directly to the client apparatus 1100 as an image forming apparatus to be used for printing by the application 128, when the application 128 operating on the server apparatus 120 is remotely operated from the client apparatus 1100. The client apparatus 1100 and the printer 1150 have serial interfaces 1101 and 1151, respectively, through which the client apparatus 1100 and the printer 1150 are connected to each other.

The link system 2 according to the second embodiment is the same as the link system 1 except that the remote operation host apparatus is the client apparatus 1100 instead of the MFP 100 of the link system 1 in the first embodiment. In addition to the serial interface 1101 described above, the client apparatus 1100 includes, as in the case of the MFP 100, an NIC 101, a CPU 102, an input section 103, a display section 104, an authentication section 107, a memory section 108, a universal OS 109, an authenticator 110, a remote connection driver 111, and a setting switching section 112.

In the link system 2, when the remote connection driver 111 of the client apparatus 1100 starts the application 128 on the server apparatus 120 by remote control, the client apparatus 1100 transmits the operation start signal to the server apparatus 120 over the network 140. And the server apparatus 120 receives the operation start signal transmitted from the client apparatus 1100 and on the basis of the operation start signal, the device setting manager 127 identifies as the remote operation host apparatus the client apparatus 1100 which has transmitted the operation start signal. Furthermore, on the basis of the identification result, the device setting manager 127 of the server apparatus 120 automatically sets the printer 1150 connected directly to the client apparatus 1100 serving as the remote operation host apparatus as an image forming apparatus to be used for printing by the application 128. And then, a CPU 1152 mounted in the printer 1150 processes a control command transmitted from the client apparatus 1100 through the serial interface 1151 and controls an image forming apparatus 1153 to print to a recording medium the print data created by using the application 128 on the server apparatus 120. A user making use of the link system 2 therefore does not need to conduct such operation for each use as to select and set an image forming apparatus which is to be used for printing by the application 128, thus allowing for enhancement in convenience.

Additionally, in the case where the communication protocol for use in the device setting manager 127 of the server apparatus 120 is an HTTP, for example, the client apparatus 1100 is similar to the remote login system in the server apparatus 120 which uses the remote desktop connection of WINDOWS XP (registered trademark) or later version. In this system, the server apparatus 120 identifies a user making use of the client apparatus 1100 and transmits to the client apparatus 1100 a desktop screen which is based on user information of the identified user. This allows the client apparatus 1100 to manipulate the GUI screen of the application 128 on the server apparatus 120. And the print data is printed on a recording medium by the printer 1150 connected directly to the client apparatus 1100.

Further, when the operational mode is switched to the manual mode by the setting switching section 112 in the client apparatus 1100 so that the image forming apparatus to be used for printing by the application is manually set at will and that the server apparatus 120 controls the printer manually set at will, the server apparatus 120 may, as in the case of the first embodiment, start the control of the output printer after the predetermined time has elapsed since reception of the operation start signal from the client apparatus 1100, and set the parameters in the device driver 124 for the output printer as well as transmit the print data. Alternatively, the server apparatus 120 may start the control of the output printer at the predetermined time point and set the parameters in the device driver 124 for the output printer as well as transmit the print data. Furthermore, the server apparatus 120 may be adapted to awake from the standby mode and start the control of the output apparatus after the command indicative of onset of the control is entered on the input section such as a touch panel, of the client apparatus connected to the output printer.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A link system in which a plurality of image forming apparatuses and a server apparatus are connected so as to enable data communication over a network,
the image forming apparatus having a remote operating section adapted to make an application on the server apparatus available by remote control, and
the server apparatus having:
a remote operation host apparatus identifying section for identifying a remote operation host apparatus that is an image forming apparatus which is currently performing a remote operation, with the remote operating section, among the plurality of image forming apparatuses connected over a network; and
an automatic setting section adapted to automatically set an image forming apparatus to be used for printing a print job of an application,
wherein the remote operating section of the image forming apparatus starts an application on the server apparatus by remote control,
the image forming apparatus transmits over a network an operation start signal indicative of onset of the remote control, and
the server apparatus receives the operation start signal transmitted from the image forming apparatus, based on which signal:
the remote operation host apparatus identifying section identifies as a remote operation host apparatus the image forming apparatus having transmitted the operation start signal; and
based on an identification result of the remote operation host apparatus identifying section, the automatic setting section automatically sets as the remote operation host apparatus an image forming apparatus to be used for printing by the application.

2. The link system of claim 1, wherein the image forming apparatus has a memory section for storing user information registered in advance for each user making use of the image forming apparatus, and an authentication section for identifying and authenticating a user based on the user information stored in the memory section, and
the server apparatus has a user identifying section for identifying a user making use of an application by remote control, and a memory section for storing custom setting registered in advance for each user making use of the application by remote control,
wherein when the remote operating section of the image forming apparatus starts an application on the server apparatus by remote control,
the image forming apparatus transmits user information of a user authenticated by the authentication section, to the server apparatus over a network, and
the server apparatus receives the user information transmitted from the image forming apparatus, based on which information:
the user identifying section identifies a user making use of the application by remote control via a remote operation host apparatus identified by the remote operation host apparatus identifying section, and
the automatic setting section initializes the remote operation host apparatus with custom setting associated with the user identified.

3. The link system of claim 1, wherein the application on the server apparatus is a PC desktop application with a graphical user interface (GUI) included, and
the remote operating section of the image forming apparatus is adapted to make the GUI provided in the application on the server apparatus available by remote control.

4. The link system of claim 1, wherein the server apparatus has an image forming apparatus driver for controlling the image forming apparatus, and
the server apparatus uses the image forming apparatus driver to control communication required for image formation and control the image forming apparatus serving as the remote operation host apparatus.

5. The link system of claim 1, wherein the server apparatus is connected to the image forming apparatus by a Web service application program interface (API), and
the server apparatus uses the Web service API to control communication required for image formation and control the image forming apparatus serving as the remote operation host apparatus.

6. The link system of claim 1, wherein the server apparatus has a plurality of applications, and
each of the applications is exclusively used by one of the plurality of image forming apparatuses serving as the remote operation host apparatuses.

7. The link system of claim 1, wherein the server apparatus has a plurality of applications,
the plurality of image forming apparatuses have the remote operating sections adapted to enable multitasking for separate remote control activation of one application among the plurality of applications provided in the server apparatus, and
the server apparatus correlates as the remote operation host apparatus the image forming apparatuses which have separately started the application by multitasking.

8. The link system of claim 2, wherein the server apparatus has a plurality of applications,
the plurality of image forming apparatuses have the remote operating sections adapted to enable multitasking for separate remote control activation of one application among the plurality of applications provided in the server apparatus, and
the server apparatus receives the user information transmitted from the image forming apparatus, based on which information:
the user identifying section identifies a user making use of the application by remote control via a remote operation host apparatus identified by the remote operation host apparatus identifying section, and
the automatic setting section initializes the remote operation host apparatus with custom setting associated with the user identified.

9. The link system of claim 2, wherein a communication protocol for use in the user identifying section is a hyper text transfer protocol (HTTP), and an HTTP request message includes the user information.

10. The link system of claim 2, wherein the communication protocol for use in the user identifying section is a simple object access protocol (SOAP), and an SOAP request massage includes the user information.

11. The link system of claim 1, wherein the image forming apparatus has a setting switching section for switching to an operational mode that manual setting is allowed so as to enable setting of the image forming apparatus to be used for printing by the application, by arbitrary selection from the image forming apparatuses connected over a network.

12. The link system of claim 11, wherein when the server apparatus controls a given image forming apparatus manually set as the image forming apparatus to be used for printing by the application, in the operational mode set by the setting switching section in the image forming apparatus,
the server apparatus starts the control after a predetermined time has elapsed since reception of the operation start signal.

13. The link system of claim 11, wherein when the server apparatus controls a given image forming apparatus manually set as the image forming apparatus to be used for printing by the application, in the operational mode set by the setting switching section in the image forming apparatus,
the server apparatus starts the control at a predetermined time point.

14. The link system of claim 11, wherein when the server apparatus controls a given image forming apparatus manually set as the image forming apparatus to be used for printing by the application, in the operational mode set by the setting switching section in the image forming apparatus,
the server apparatus starts the control after a command indicative of onset of the control is entered on an input section of the given image forming apparatus manually set.

15. A link system in which a server apparatus is linked with a client apparatus connected to an image forming apparatus so as to enable data communication over a network,
the client apparatus having a remote operating section adapted to make an application on the server apparatus available by remote control, and
the server apparatus having:
a remote operation host apparatus identifying section for identifying a remote operation host apparatus that is an image forming apparatus which is currently performing a remote operation, with the remote operating section, among the plurality of image forming apparatuses connected over a network; and
an automatic setting section for automatically setting an image forming apparatus to be used for printing a print job of an application,
wherein when the remote operating section of the client apparatus starts an application on the server apparatus by remote control,
the client apparatus transmits an operation start signal indicative of onset of the remote control to the server apparatus over a network, and
the server apparatus receives the operation start signal transmitted from the client apparatus, based on which signal:
the remote operation host apparatus section identifies as a remote operation host apparatus the client apparatus having transmitted the operation start signal; and
based on an identification result of the remote operation host apparatus identifying section, the automatic setting section automatically sets, as the image forming apparatus directly connected to the remote operation host apparatus, an image forming apparatus to be used for printing by the application.

16. The link system of claim 15, wherein the client apparatus has a memory section for storing user information registered in advance for each user making use of the client apparatus, and an authentication section for identifying and authenticating a user based on the user information stored in the memory section, and
the server apparatus has a user identifying section for identifying a user making use of an application by remote control, and a memory section for storing custom setting registered in advance for each user making use of the application by remote control,
wherein when the remote operating section of the client apparatus starts an application on the server apparatus by remote control,
the client apparatus transmits user information of a user authenticated by the authentication section, to the server apparatus over a network, and
the server apparatus receives the user information transmitted from the client apparatus, based on which information:
the user identifying section identifies a user making use of the application by remote control via a remote operation host apparatus identified by the remote operation host apparatus identifying section, and
the automatic setting section initializes an image forming apparatus directly connected to the remote operation host apparatus, with custom setting associated with the user identified.

17. The link system of claim 15, wherein the application on the server apparatus is a PC desktop application with a graphical user interface (GUI) included, and
the remote operating section of the client apparatus is adapted to make the GUI provided in the application on the server apparatus available by remote control.

18. The link system of claim 15, wherein the server apparatus has an image forming apparatus driver for controlling the image forming apparatus, and
the server apparatus uses the image forming apparatus driver to control communication required for image formation and control the image forming apparatus directly connected to the client apparatus serving as the remote operation host apparatus.

19. The link system of claim 15, wherein the server apparatus is connected to the client apparatus by a Web service application program interface (API), and
the server apparatus uses the Web service API to control communication required for image formation and control the image forming apparatus directly connected to the client apparatus serving as the remote operation host apparatus.

20. The link system of claim 15, wherein the server apparatus has a plurality of applications, and
each of the applications is exclusively used by one of the plurality of client apparatuses serving as the remote operation host apparatuses.

21. The link system of claim 15, wherein the server apparatus has a plurality of applications,
the plurality of client apparatuses have the remote operating sections adapted to enable multitasking for separate remote control activation of one application among the plurality of applications provided in the server apparatus, and
the server apparatus correlates as the remote operation host apparatus the client apparatuses which have separately started the application by multitasking.

22. The link system of claim 16, wherein the server apparatus has a plurality of applications,
the plurality of client apparatuses have the remote operating sections adapted to enable multitasking for separate remote control activation of one application among the plurality of applications provided in the server apparatus, and
the server apparatus receives the user information transmitted from the client apparatus, based on which information:
the user identifying section identifies a user making use of the application by remote control via a remote operation host apparatus identified by the remote operation host apparatus identifying section, and
the automatic setting section initializes the remote operation host apparatus with custom setting associated with the user identified.

23. The link system of claim 16, wherein a communication protocol for use in the user identifying section is a hyper text transfer protocol (HTTP), and an HTTP request message includes the user information.

24. The link system of claim 16, wherein the communication protocol for use in the user identifying section is a simple object access protocol (SOAP), and an SOAP request massage includes the user information.

25. The link system of claim 15, wherein the client apparatus has a setting switching section for switching to an operational mode that manual setting is allowed so as to enable setting of the image forming apparatus to be used for printing by the application, by arbitrary selection from the image forming apparatuses connected over a network.

26. The link system of claim 25, wherein when the server apparatus controls a given image forming apparatus manually set as the image forming apparatus to be used for printing by the application, in the operational mode set by the setting switching section in the client apparatus,
the server apparatus starts the control after a predetermined time has elapsed since reception of the operation start signal.

27. The link system of claim 25, wherein when the server apparatus controls a given image forming apparatus manually set as the image forming apparatus to be used for printing by the application, in the operational mode set by the setting switching section in the client apparatus,
the server apparatus starts the control at a predetermined time point.

28. The link system of claim 25, wherein when the server apparatus controls a given image forming apparatus manually set as the image forming apparatus to be used for printing by the application, in the operational mode set by the setting switching section in the client apparatus,
the server apparatus starts the control after a command indicative of onset of the control is entered on an input section of a client apparatus connected to the given image forming apparatus manually set.
